(19) United States
(12) Patent Application Publication
(10) Pub. No.: US 2015/0184708 A1
(43) Pub. Date: Jul. 2, 2015

(54) Disc Brake for a Commercial Vehicle

(71) Applicant: KNORR-BREMSE Systeme fuer Nutzfahrzeuge GmbH, Muenchen (DE)

(72) Inventors: Jose CAMILO-MARTINEZ, Unterhaching (DE); Wolfgang PRITZ, Muenchen (DE)

(21) Appl. No.: 14/577,557

(22) Filed: Dec. 19, 2014

Related U.S. Application Data
(63) Continuation of application No. PCT/EP2013/063508, filed on Jun. 27, 2013.

(30) Foreign Application Priority Data
Jun. 28, 2012 (DE) 10 2012 012 818.5

(51) Int. Cl. F16D 65/00; F16D 65/52

(52) U.S. Cl. CPC F16D 65/0068; F16D 65/52

(57) ABSTRACT

A disc brake for a commercial vehicle is provided, having a brake caliper extending over a brake disc, and a pivotable brake lever arranged in the brake caliper with which brake lever, via a connected centrally arranged brake plunger, a brake pad can be pressed against the brake disc during braking The disc brake is designed such that the spring-loaded brake plunger contacting the brake lever has a rotatable core spindle furnished with an external thread and a spindle nut retained thereon, onto which a pressure pad that contacts a pad support plate of the brake pad in a rotationally fixed manner is moulded on the side of the nut facing away from the brake lever.

### BACKGROUND AND SUMMARY OF THE INVENTION

The invention relates to a disc brake for a commercial vehicle having a brake caliper extending over a brake disc, and a pivotable brake lever, which is arranged in the brake caliper and with which, via a connected centrally arranged brake plunger, a brake pad can be pressed against the brake disc during braking.

A disc brake of this kind, which can be actuated pneumatically or electromechanically, has a centrally arranged brake plunger which can be pressed against the application-side brake pad by means of a pivoted lever.

This brake plunger is designed as a threaded tube having an external thread, in which an adjuster for compensating a wear-related change in release clearance is arranged.

In this case, the threaded tube is rotatably mounted in a bridge and is adjusted axially to such an extent in the direction of the brake disc through rotation by means of the adjuster that a constant release clearance is obtained.

For rotation of the brake plunger, i.e. of the threaded tube, freely rotatable attachment to the associated brake pad is required, for which purpose a pressure piece resting on a pad support plate of the brake pad is formed as a pivot bearing in the common region of connection so as to correspond to the brake plunger. However, there is a whole series of regrettable disadvantages due to this design, both in terms of production engineering and also of functioning.

Thus, implementation of the rotatable arrangement of the threaded tube, that is of the brake plunger, on the pressure piece, which moreover rests loosely on the pad support plate, requires production engineering measures which have an extremely disadvantageous effect on production costs.

Among these there is, in particular, the required outlay on forming to attach the pressure piece to the brake plunger, which must ensure axial securing of both functional parts relative to one another, on the one hand, and the relative rotatability thereof, on the other.

In order to obtain a permanently mobile bearing location between the pressure piece and the brake plunger, the practice hitherto has therefore been to provide a “DU bearing”, although this can be provided only with a very high outlay.

Since the articulated connection between the pressure piece and the brake plunger is positioned directly in the region of engagement of the brake pad on the brake disc, this articulated connection is also subject to particular stresses, especially temperature stresses, owing to the frictional heat which arises during a braking operation.

This thermal stress ultimately leads to a reduction in service life, especially since there is a risk that the joint will be involved in such a way that the necessary rotatability is no longer possible to the desired extent.

It is the underlying object of the invention to develop a disc brake of the type in question in such a way that it can be produced more cheaply and that its functioning capacity or service life is improved.

This object is achieved by a disc brake having a brake caliper extending over a brake disc, and a pivotable brake lever, which is arranged in the brake caliper and with which, via a connected centrally arranged brake plunger, a brake pad can be pressed against the brake disc during braking The brake plunger, which rests under a spring load on the brake lever, has a rotatable core spindle, which is provided with an external thread, and a spindle nut held thereon, onto which a pressure piece that rests on a pad support plate of the brake pad in a manner fixed against relative rotation is molded on the side of the nut facing away from the brake lever.

By means of the invention, it is possible, in principle, to dispense with the use of a bridge in the brake caliper since the brake plunger, i.e. the core spindle provided according to the invention, is now supported directly on the brake lever. Thus, the core spindle assumes both the function of brake force transmission and also that of axial adjustment for compensation of the release clearance.

The new design provides the possibility of enabling the adjuster to engage on the outside of the brake plunger, namely on the core spindle, which for this purpose has a gearwheel fixed against relative rotation which corresponds to a spur wheel of the adjuster.

The lateral arrangement of the adjuster relative to the brake plunger, in which a drive spindle of the adjuster extends parallel to the brake plunger, allows a very compact construction of the disc brake overall.

Since there is now no longer an articulated connection between the pressure piece and the brake plunger, the disadvantages described in that context are also eliminated. These include the elimination of machining of the bearing assembly on both sides, i.e. of the brake plunger and of the pressure piece, and of the use of the DU bearing assembly mentioned.

The spindle nut and the pressure piece are preferably formed integrally as a casting, allowing production in a manner which is particularly simple and therefore minimizes costs. Thus, all that is required for the full functioning, even of the thread engagement of the spindle nut with the core spindle, is slight mechanical machining

For rotatable mounting of the core spindle on the brake lever, a spherical cup can be formed in the end of the core spindle on the side opposite the pressure piece, into which cup a ball is inserted as a bearing, resting on the other side in a matching receptacle on the brake lever.

The spherical cup and/or the receptacle on the brake lever can be lined with a suitable bearing material but this is not subject to particular thermal stress, in contrast to the joint on the pressure piece according to the prior art.

According to the invention, full functioning of the brake plunger is ensured by securing the spindle nut on the pressure piece in a manner secure against rotation, wherein the pressure piece is formed integrally on the spindle nut. On the other side, the pressure piece must likewise be held in a manner secure against rotation, for which purpose a corresponding engagement with the pad support plate of the associated brake pad is provided.

This engagement is preferably positive, e.g. by means of corresponding recesses in the pad support plate, into which projections on the pressure piece engage. However, other positive engagement means are also conceivable, such as hooks or the like formed integrally on the pad support plate, into which tabs on the pressure piece are inserted.

In order to keep the surface pressure which occurs during braking due to the braking forces which arise relatively small, the pressure piece is preferably designed as a pressure plate with a relatively large contact surface on the pad support plate.

The pad support plate is normally likewise designed as a casting, thus allowing said positive engagement means for retaining the pressure piece to be cast on or in at the same time.

If the pad support plate is designed as a formed sheet-metal part, the stops can likewise be formed integrally during production.

In no case is additional work required for implementation of the safeguard against relative rotation, and therefore the novel disc brake can to this extent be produced at neutral cost.

Further advantageous embodiments of the invention are described and claimed herein.

### BRIEF DESCRIPTION OF THE DRAWINGS

An illustrative embodiment of the invention is described below by means of the attached drawings, in which:

FIG. 1 shows part of a disc brake according to the invention in a partially sectioned plan view

FIG. 2 shows a detail of the disc brake according to FIG. 1 in a partially sectioned perspective view; and

FIG. 3 shows a detail of the disc brake according to FIG. 1, likewise in a perspective view.

### DETAILED DESCRIPTION OF THE DRAWINGS

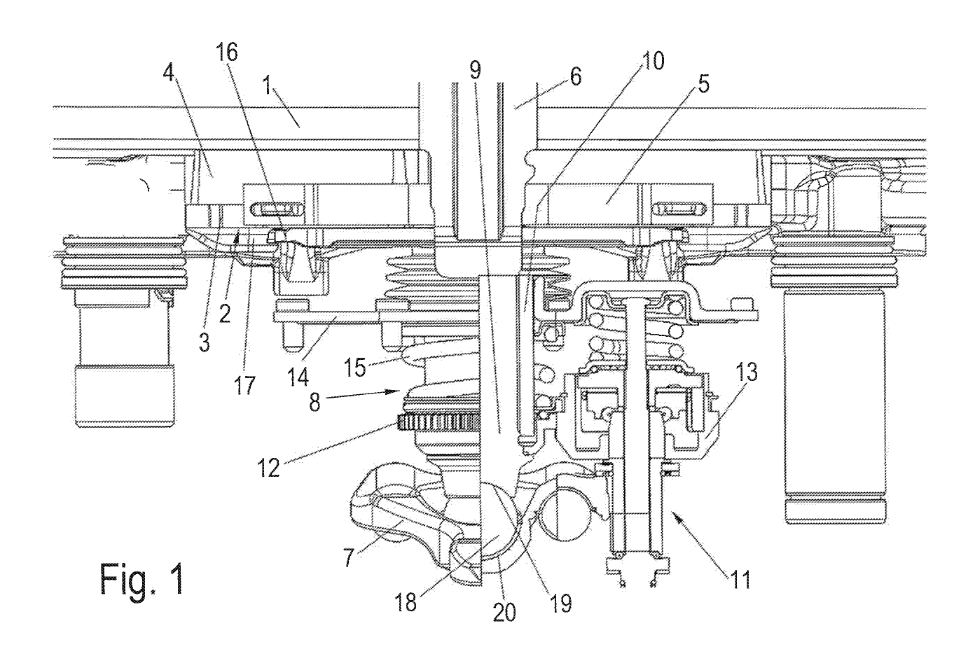

Part of the disc brake can be seen in a schematic representation in FIG. 1, having a brake disc 1, over which there extends a brake caliper (not shown), which is designed as a sliding caliper and in which are arranged two brake pads 2, of which only a brake pad on the application side can be seen. In operation, i.e. during a braking process, the brake pads 2 can be pressed against the brake disc 1.

In this case, the brake pad 2 shown, which is on the application side, is first of all pressed against the brake disc 1 by means of a brake lever 7, which is pneumatically or electromechanically actuable, with the aid of an axially movable brake plunger 8. The brake pad 2 on the reaction side is pressed against the brake disc 1 subsequently owing to the reaction forces, through the sliding action of the brake caliper.

Each brake pad 2 comprises a pad support plate 3 and a friction pad 4 secured thereon, which friction pad 4 comes into contact with the brake disc 1 during a braking process.

Secured on the pad support plate 3 is a pad holding spring 5 which, in interaction with a holding clip 6, holds the brake pads 2 under preload in a pad recess of the brake caliper or of a brake carrier.

The brake plunger 8 is arranged centrally and can be pressed against the brake pad 2 on the application side by means of a pressure piece 16. Here, the brake plunger 8 comprises a core spindle 9 provided with an external thread and a spindle nut 10, into which the core spindle 9 is screwed.

A gearwheel 12 is fixed on the core spindle 9 and is in engagement with a spur wheel 13 of an adjuster 11, which is arranged next to the brake plunger 8 and, on the one hand, is held on the brake caliper and, on the other hand, is connected firmly to a closure cover 14, by means of which an assembly opening for receiving functional parts of the brake caliper can be closed.

Moreover, the brake plunger 8 rests under spring load on the brake lever 7, for which purpose a helical spring in the form of a compression spring 15 is guided on the brake plunger 8 and is supported, on the one hand, on the gearwheel 12 and, on the other hand, on a supporting plate 22, which rests on the closure plate 14.

The end of the core spindle 9 remote from the brake disc 1 is designed as a spherical cup 19, in which there rests a ball 18, which is supported on the other side in a receptacle 20 of the brake lever 7, with the result that the core spindle 9 is mounted rotatably on the brake lever 7.

When the brake lever 7 is actuated, the spur wheel 13 of the adjuster 11 and hence, via the gearwheel 12, the core spindle 9 is rotated.

The spindle nut 10 is fixed relative to the core spindle 9 so that, when the core spindle 9 rotates, the spindle nut 10 moves axially, namely in the direction of the brake disc 1.

To mount the spindle nut 10 in a manner fixed against relative rotation, it is formed integrally on the pressure piece 16 designed as a pressure plate, which is held positively on the associated pad support plate 3 of the brake pad 2.

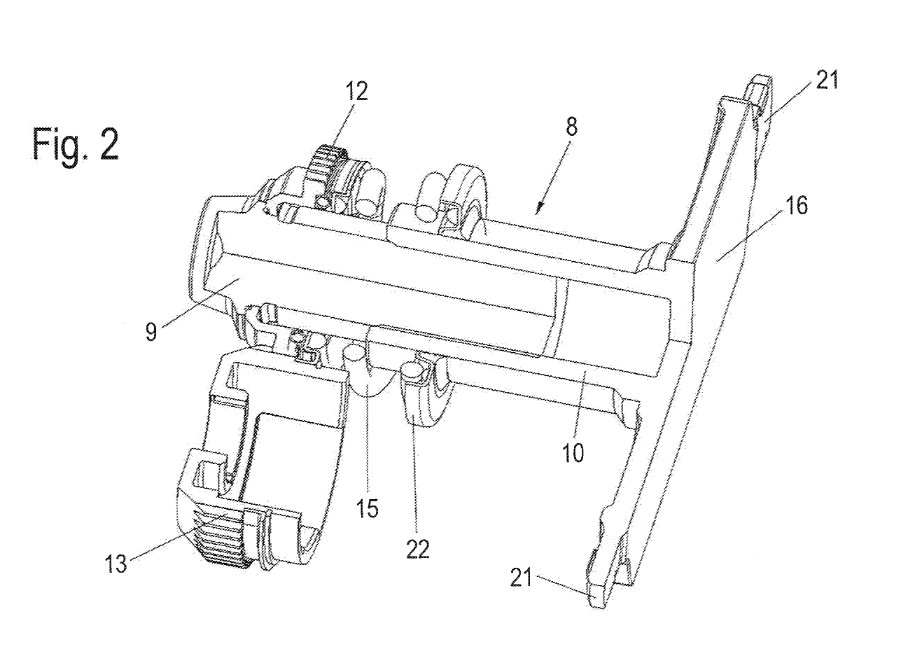

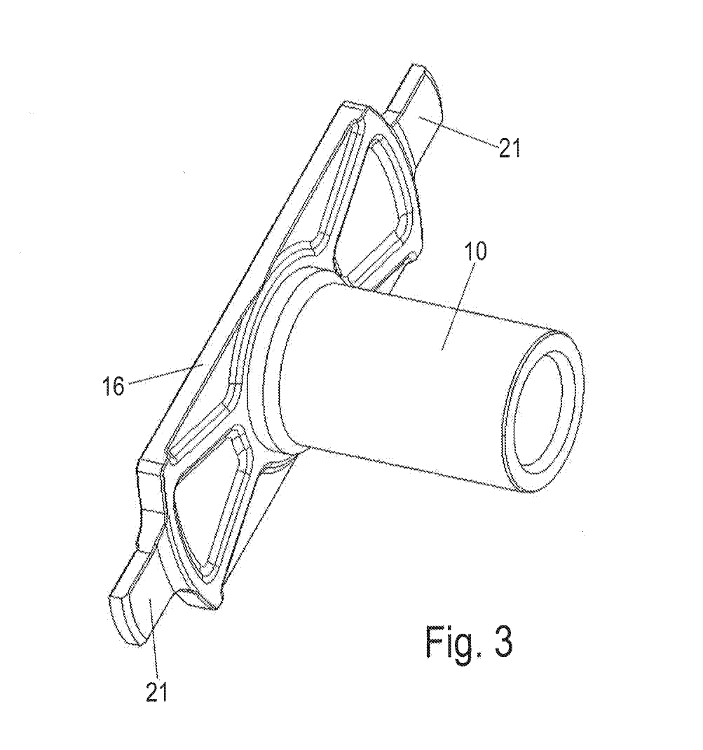

For this purpose, as FIGS. 2 and 3, in particular, show very clearly, the pressure piece 16 has tabs 21 on opposite corners, which engage in undercuts 17 (FIG. 1) in the pad support plate 3.

### LIST OF REFERENCE SIGNS

1 brake disc
2 brake pad
3 pad support plate
4 friction pad
5 pad holding spring
6 holding clip
7 brake lever
8 brake plunger
9 core spindle
10 spindle nut
11 adjuster
12 gearwheel
13 spur wheel
14 closure plate
15 compression spring
16 pressure piece
17 undercut
18 ball
19 spherical cup
20 receptacle
21 tab
22 supporting plate

1-7. (canceled)

8. A disc brake for use with a brake disc, comprising:
a caliper configured to extend over the brake disc;
a pivotable brake lever arranged in the caliper;
a centrally arranged brake plunger by which the pivotable brake lever presses a brake pas against the brake disc during braking, the brake plunger resting under a spring load on the brake lever;
wherein the brake plunger comprises a rotatable core spindle provided with an external thread, and a spindle nut provided on the rotatable core spindle; and
wherein a pressure piece that rests on a pad support plate of the brake pad in a manner fixed against relative rotation is molded on a side of the spindle nut that faces away from the brake lever.

9. The disc brake according to claim 8, wherein the pressure piece and the spindle nut are a single cast part.

10. A disc brake according to claim 8, wherein the pressure piece is fixed against relative rotation via a positive engagement of the pressure piece on the pad support plate.

11. A disc brake according to claim 9, wherein the pressure piece is fixed against relative rotation via a positive engagement of the pressure piece on the pad support plate.

12. The disc brake according to claim 8, wherein the pressure piece has a plate-shape with tabs extending on mutually opposite edge regions of the plate-shape, the tabs engaging in undercuts in the pad support plate to fix the pressure piece against relative rotation.

13. The disc brake according to claim 9, wherein the pressure piece has a plate-shape with tabs extending on mutually opposite edge regions of the plate-shape, the tabs engaging in undercuts in the pad support plate to fix the pressure piece against relative rotation.

14. The disc brake according to claim 8, further comprising:
an adjuster comprising a spur wheel engaging with a gearwheel held in a manner fixed against relative rotation on the core spindle; and
wherein the adjuster is arranged adjacent to the brake plunger.

15. The disc brake according to claim 9, further comprising:
an adjuster comprising a spur wheel engaging with a gearwheel held in a manner fixed against relative rotation on the core spindle; and
wherein the adjuster is arranged adjacent to the brake plunger.

16. The disc brake according to claim 12, further comprising:
an adjuster comprising a spur wheel engaging with a gearwheel held in a manner fixed against relative rotation on the core spindle; and
wherein the adjuster is arranged adjacent to the brake plunger.

17. The disc brake according to claim 14, further comprising:
a closure plate configured to close an assembly opening in the caliper;
a compression spring supported at one end on the closure plate and, at another end on the gearwheel, the compression spring being guided on the brake plunger to provide the spring load on the brake plunger against the brake lever.

18. The disc brake according to claim 12, wherein the tabs of the pressure piece rests on stops on the pad support plate.

19. The disc brake according to claim 13, wherein the tabs of the pressure piece rests on stops on the pad support plate.
